(19) United States
(12) Patent Application Publication
(10) Pub. No.: US 2006/0003065 A1
(43) Pub. Date: Jan. 5, 2006

(54) Dry-base aerated food product dispensing method and apparatus

(76) Inventor: Paul R. Kateman, Wellesley, MA (US)

Correspondence Address: Alison L. McCarthy;Mintz, Levin, Cohn, Ferris,, Glovsky and Popeo, P.C, One Financial Center, Boston, MA, 02111, US

(21) Appl. No.: 10/884,683

(22) Filed: Jul. 1, 2004

(51) Int. Cl. A21D 13/00

(52) U.S. Cl. 426/506

(57) ABSTRACT

A method of producing and dispensing a food product provides a supply of product base in the form of a dry powder, mixes a selected amount of that powder with a selected amount of water to produce a selected volume of powder base/water mix. That volume is then flowed along a confined turbulence passage so that the powder base dissolves thoroughly in the water to form a selected volume of liquid product base. At a location further along the passage, air is injected into the liquid product base to give the liquid product base a selected amount of aeration whereby a selected volume of a homogenous aerated liquid product exits the passage. Flavor may be added to the aerated liquid product and that product may be at least partially frozen to form a frozen confection. Apparatus for carrying out the method is also disclosed.

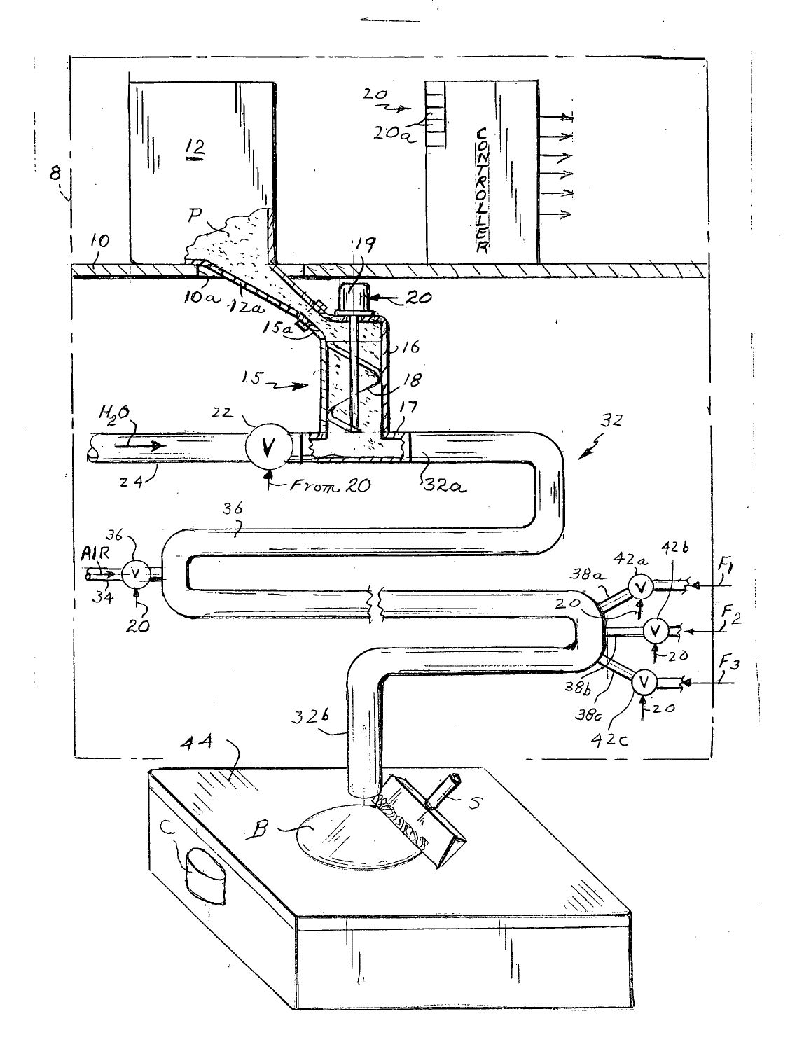

### BACKGROUND OF THE INVENTION

1. Field of the Invention

This invention relates to a method and apparatus for producing and dispensing an aerated and/or blended food product derived from a dry product base. It has a particular application to the production and dispensing of frozen confections such as ice cream and frozen yogurt. Consequently, we will describe the invention in that context. It should be understood, however, that various aspects of the invention to be described may also have application to the making and dispensing of various other dry-base products.

2. Description of the Prior Art

Aerated frozen food products generally require the mixing of a selected base ingredient with a prescribed volume of air and the freezing of the resultant aerated mixture followed by the dispensing of the finished product. A flavoring may be introduced into the mixture prior to its being frozen. The desirability of the product is often related directly the to the manner and the degree in which the air is metered and blended with the base ingredient(s) of the mixture, referred to as overrun, and the manner in which the blended mix is frozen and then dispensed. The prior art is replete with examples of apparatus for dispensing ice cream and other semi-frozen dairy products such as soft ice cream and frozen yogurt. See for example, my U.S. Pat. Nos. 5,433,967; 5,727,713 and 6,698,228, the contents of which are hereby incorporated by reference.

All of the prior dispensing machines of this general type of which we are aware utilize a product base which is in a liquid form, e.g. a liquid ice cream base, liquid yogurt base, etc. Containers containing a volume of a liquid base sufficient for even a relatively large number of servings are quite heavy. For example, a 5-gallon container can weigh over 45 pounds. Therefore, they are difficult to handle and to lift up into the dispenser and to handle generally while being shipped through the required trade channels. Often the containers are dropped resulting in leakage and spillage of the container contents. In extreme cases, the containers may burst on impact so that the container contents flood the area of impact. Needless to say, this can materially increase the downtime of the affected dispenser and gives rise to health and sanitation concerns in the general area of that dispenser and in shipping and handling areas generally.

### SUMMARY OF THE INVENTION

Accordingly, it is an object of the present invention to provide apparatus for producing and dispensing a food product from a product base consisting of a dry particulate material or powder.

A further object of the invention is to provide such apparatus which is capable of producing and dispensing a variety of different frozen confections such as ice cream, low-fat ice cream, frozen yogurt, etc.

A further object of the invention is to provide apparatus for producing and dispensing frozen confections which can be stocked with product base in a minimum amount of time and with minimum effort.

Another object of the invention is to provide such apparatus which presents fewer shipping and handling problems than prior machines utilizing a liquid as the product base.

Yet another object of the invention is to provide a method of making and dispensing a frozen confection which has one or more of the above advantages.

Other objects will, in part, be obvious and will, in part, appear hereinafter.

The invention accordingly comprises sequence of steps and the features of construction, combination of elements and arrangement of parts to carry out those steps as exemplified in the following detailed description, and the scope of the invention will be indicated in the claims.

Briefly, the present apparatus produces and dispenses a frozen or partially frozen food product starting from a product base consisting of a dry particulate material or powder. When a particular frozen product is selected for dispensing, e.g. a scoop of chocolate ice cream, a measured amount of the powder base for that product is released from its container into a turbulence passage where it is entrained in a measured volume of water whose temperature is preferably such as to optimize the dissolving of the powder base in the water. That passage has an inside diameter and length such as to create confined turbulent mixing of the liquid and powder flowing through the passage. Resultantly, the powder base is thoroughly dissolved in the water to form a liquid product base.

At a selected location along the passage, air is injected into the passage to aerate the liquid product base so that by the time the base reaches the distal or outlet end of the passage, the ice cream powder base, water and air will have combined to form a homogenous aerated liquid ice cream intermediate.

A measured amount of liquid flavoring, i.e. chocolate syrup in this case, may be introduced into the aerated liquid stream relatively near the outlet end of the passage. Thus, a measured amount of flavored aerated liquid product exits the passage and may be deposited on a freezing surface to produce an at least partially solidified product body. Thereupon, that solidified product body may be scraped from the freezing surface and formed into the selected frozen product, i.e. a scoop of chocolate ice cream, which scoop may then be placed in a cup or cone before being served to a customer.

A given dispenser may have several containers containing different dry product bases such as ice cream, low-fat ice cream, soy, sorbet, yogurt, etc., and several containers holding a variety of different flavors such as chocolate, vanilla, pistachio, strawberry, etc. Thus, the apparatus is able to produce and dispense individualized portions of freshly aerated and flavored frozen product, on demand, and in different formats, e.g. a cup or cone.

It should also be understood that various aspects of the invention may be used to mix, blend and dispense various other hot or cold food products such as hot chocolate, instant soups, juices, omelets, crepes, flavored milks, and any other product that can be produced from a dry powder or particulate base material.

### BRIEF DESCRIPTION OF THE DRAWINGS

For a fuller understanding of the nature and objects of the invention, reference should be made to the following detailed description taken in connection with the accompanying drawing which is a diagrammatic view of apparatus for producing and dispensing a frozen food product in accordance with the invention.

### DETAILED DESCRIPTION OF THE PREFERRED EMBODIMENT

Referring to the drawing FIGURE, my apparatus for producing and dispensing an aerated frozen food product from a dry base comprises a housing 8 having an internal shelf 10 capable of supporting one or more relatively large containers 12, each filled with a food product base consisting of a dry powder or particulate material P. Container(s) 12 may be inserted into housing 8 in an inverted condition and slid onto shelf 10, the shelf being provided with a notch 10a to provide clearance for a container outlet 12a which extends down below the shelf so that it can be coupled to the inlet port 15a of a metering device shown generally at 15 supported below the shelf. The container outlet 12a may be closed by a removable plastic or foil cover (not shown) until the container 12 is coupled to the metering device 15.

The illustrated metering device 15 is a screw feeder consisting of cylindrical housing 16 with inlet port 15a opening into one end. The opposite end of housing 16 opens into a tube section 17. Rotatably mounted in housing 16 is an auger 18. Auger 18 may be rotated by a step motor 19 controlled by a controller 20 on shelf 10. Each time auger 18 is turned by motor 19 through a given angle, a selected amount of powder P from the container 12 will be introduced into tube section 17.

One end of tube section 17 is connected by way of a valve 22 to a pipe 24 leading from a source of water under pressure. Valve 22 is opened and closed at the appropriate times by controller 20. Pipe 24 may receive water directly from a water mains or from a water storage container (not shown) inside housing 8. Preferably, the water entering pipe section 17 has a temperature which optimizes the mixing process to be described presently.

The opposite end of tube section 17 is connected to the inlet end 32a of a relatively long, i.e., about three feet, tube 32. When valve 22 is open and the metering device 15 injects powder P into tube section 17, the powder is entrained in the water stream and carried into tube 32. The tube defines a confined turbulent mixing passage such that in its travel along the tube, the powder becomes thoroughly dissolved in the water to form a homogenous liquid product base. Of course, that passage could be formed directly in a metal or plastic block or manifold.

At a selected location along tube 32, air is introduced into the tube via a pipe or tube 34 to aerate the volume of liquid product base flowing along the tube. The pipe may receive air under pressure from a compressor (not shown) in housing 8 or from an external source. Pipe 34 includes a valve 36 which is opened and closed by controller 20 so that each volume or charge of liquid product base from metering device 15 receives a selected amount of air. This controls the aeration or so-called overrun in the final product.

The liquid, and now aerated, product base continues its course along tube 32 so that by the time it reaches the tube outlet end 32b, it is a thoroughly homogenous aerated liquid product base or liquid product intermediate.

Under normal circumstances, one or more flavors are introduced into the aerated liquid product base usually, but not necessarily, before the base reaches the tube outlet end 32b. Thus, in the illustrated apparatus, three pipes or tubes 38a, 38b and 38c are connected to tube 32. These pipes lead to containers (not shown) containing three different liquid flavors F₁, F₂ and F₃, e.g. chocolate, strawberry and banana flavors. The three tubes include corresponding in-line valves 42a, 42b and 42c which, under the control of controller 20, selectively introduce a given flavor or flavors into the liquid product base about to exit tube 32. Preferably, a sufficient length of tube 32, e.g. 6 to 9 inches, is present downstream from pipes 38a to 38c that the flavor(s) is thoroughly mixed with the base so that a homogenous aerated and flavored liquid product exits tube 32 at outlet end 32b.

If the measured amount of aerated liquid product exiting tube 32 is ice cream or the like, it may be deposited on a refrigerated freezing surface 44 as shown. The surface 44 may be a stationary or moving plate or a rotary drum as disclosed in my above patents. Suffice it to say that the liquid product deposited on surface 44 freezes or partially freezes to form a thin, at least partially solidified product body B. That body may then be removed from surface 44 using, for example, a hand scraper S and deposited into a suitable container such as a dish, cup or cone. Automatic means for such removal and deposit are disclosed in my above U.S. Pat. Nos. 5,433,967 and 6,698,228.

As noted above, the housing 8 of a given dispenser may have more than one container 12 for holding different dry product bases, e.g. ice cream, low fat ice cream, yogurt, etc. Each container may be provided with its own metering device 15, tube 32, etc. for processing that base to form the finished flavored product. Alternatively, several metering devices 15 may feed different base powders into the same tube 32 to dispense the product.

The base and flavor selections may be made by pressing appropriate buttons or keys on a keyboard 20a of controller 20. When a selection is made, controller 20 opens valve 26 for a selected period of time so that a measured amount of water is introduced into the tube section 17. At the same time, the metering device 15 serving the container 12 containing the selected powder base is activated by controller 20. This results in that device's auger 18 being rotated through the necessary angle to introduce a selected amount of powder P into the water stream flowing through tube section 17.

The water and the powder P flow into tube 32 and are turbulently mixed so that the powder dissolves completely in the water to form a homogenous liquid base. That liquid base charge enters tube 32 whereupon controller 20 opens valve 36 thereby injecting air into that liquid base so as to aerate the base. That fixed volume of liquid continues its travel along tube 32 undergoing turbulent mixing in the process so that the air is distributed uniformly as tiny bubbles throughout that liquid base.

When the charge of liquid product base reaches the flavor injection segment of the tube 32, controller 20 opens one (or perhaps more) of the valves 42a to 42c thereby injecting a fixed volume of the selected flavor(s) into that charge. In the remaining segment of the tube, that flavor(s) becomes thoroughly mixed with the aerated liquid product base so that a thoroughly homogenous aerated and flavored liquid base product leaves tube 32 and is deposited on the freezing surface 44 where it quickly freezes to form the at least partially frozen product body B. That body may then be scraped or otherwise removed from surface 22 by a scraper S and pressed into an appropriate container C to form a shaped food product.

It will be seen from the foregoing that since the frozen products dispensed from the described apparatus derive from a dry powder base, the container or containers 12 in housing 10 weigh as much as 55-60% less than liquid base container(s) providing the same number of servings. This makes it easier to restock the dispenser and reduces the incidence of container breakage and spillage due to the dropping of containers during shipping and handling. The dispensing of product starting from a powder base also makes it easier to maintain the dispenser areas and shipping and handling areas in a sanitary condition. Yet with all of these advantages, the described apparatus should be no more expensive to make than prior comparable dispensers of this general type.

It will thus be seen that the objects set forth above among those made apparent from the preceding description are efficiently attained and, since certain changes may be made in carrying out the above method and in the construction set forth without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention described herein.

What is claimed is:

1. A method of producing and dispensing a food product comprising the steps of
providing a supply of product base in the form of a dry powder;
mixing a selected amount of said powder with a selected amount of water to produce a selected volume of powder base/water mix;
flowing said powder base/water mix along a confined turbulence passage so that the powder base dissolves in the water to form a selected volume of liquid product base;
subsequently injecting air into the liquid product base flowing along said passage to give the liquid product base a selected amount of aeration whereby a selected volume of a homogenous aerated liquid product exits the passage.

2. The method defined in claim 1 including the additional step of injecting a selected amount of at least one liquid flavor into the liquid product base charge flowing along said passage at a location downstream from the air injection point so as to impart flavor to said aerated liquid product base.

3. The method defined in claim 2 and including the additional step of at least partially freezing the aerated and flavored liquid product that exits the tube.

4. Apparatus for producing and dispensing a food product, said apparatus comprising
an elongated confined turbulent mixing passage having an inlet end and an outlet end;
a controllable source of water for introducing water under pressure into the inlet end of said mixing passage;
a container containing a powder base and having an outlet;
a controllable metering device connected between the container outlet and said mixing passage downstream from the inlet end thereof for introducing powder base from the container into the mixing passage;
a compressed air source including a controllable air valve connected to the mixing passage downstream from the metering device connection thereto;
a controller connected to and controlling the metering device, and water and air sources so that, upon command,
a selected amount of water under pressure is fed into the inlet end of the mixing passage and a selected amount of powder base is introduced into the mixing passage and mixed with the water therein to produce a selected volume of powder base/water mix which flows along the mixing passage under turbulent flow conditions so that the powder is thoroughly dissolved in the water to form a selected volume of liquid product base, and
thereafter the air valve is opened so that a selected amount of air is injected into said volume of liquid product base, said air being thoroughly distributed throughout said volume before the volume reaches the outlet end of the mixing passage whereby a homogenous aerated liquid product exits the mixing passage.

5. The apparatus defined in claim 4 and further including at least one liquid flavor source, each flavor source including a controllable normally closed flavor valve connected to the mixing passage downstream from the compressed air source connection to the mixing passage, said controller momentarily opening the flavor valve of said at least one flavor source so as to inject a selected amount of flavor into said charge.

6. The apparatus defined in claim 5 and further including a refrigerated freezing surface positioned opposite the outlet end of the mixing passage for receiving and at least partially freezing the aerated and flavored liquid product exiting the mixing passage to form an at least partially solidified product body on said surface.

7. The apparatus defined in claim 6 and further including a scraper for removing the product body from said surface as scrapings.

8. The apparatus defined in claim 7 and further including a forming device for forming said scrapings into a shaped food product.
